(19) United States
(12) Patent Application Publication
(10) Pub. No.: US 2019/0019208 A1
(43) Pub. Date: Jan. 17, 2019

(54) CONSUMER DATA AND PRIVACY CONTROLS IN A SOCIAL NETWORKING ENVIRONMENT

(71) Applicant: Richard Postrel, Miami Beach, FL (US)

(72) Inventor: Richard Postrel, Miami Beach, FL (US)

(21) Appl. No.: 16/018,698

(22) Filed: Jun. 26, 2018

Related U.S. Application Data
(63) Continuation-in-part of application No. 15/949,486, filed on Apr. 10, 2018.
Application No. 15/949,486 is a continuation-in-part of application No. 14/788,985, filed on Jul. 1, 2015.
Application No. 14/788,985 is a continuation of application No. 13/413,416, filed on Mar. 6, 2012, now Pat. No. 9,105,043.
(60) Provisional application No. 62/508,034, filed on May 18, 2017.
(60) Provisional application No. 62/517,134, filed on Jun. 8, 2017.
(60) Provisional application No. 62/625,519, filed on Feb. 2, 2018.

(51) Int. Cl. G06Q 30/02; H04L 29/08; G06F 17/30; G06Q 50/00; H04L 29/06

(52) U.S. Cl. CPC G06Q 30/0214; H04L 67/306; H04L 67/22; H04L 67/20; H04L 63/102; G06Q 50/01; G06Q 30/0236; G06Q 30/0224; G06F 17/30867

(57) ABSTRACT

Social network members control access to and utilization of their data. Static information associated with the member is acquired, and computer-based activities of the member are recorded to generate dynamic information associated with the member. A set of member preferences are acquired from the member, including an identification of a third party to whom access of the member profile is granted by the member in exchange for compensation to the member. A member profile is constructed including the static information associated with the member, the dynamic information associated with the member, and the member preferences. The member profile is transmitted to the third party identified in the member preferences, and compensation is provided to the member exchange for access to the member profile. The member profile is stored in a blockchain ledger and is updated by recording each computer-based activity to a record in the blockchain ledger.

### TECHNICAL FIELD

This invention relates to social networking commerce and rewards/incentives, and in particular to methods and systems for utilizing social networks for advertisers and marketers to permissively collect and analyze data from their users/members, target and distribute advertising to and from members of social networks by providing incentives, rewards and other compensation, wherein each member maintains complete and detailed control over the access to and use of their private data. This invention also relates to the use of blockchain methodologies for awarding, tracking, aggregating, redeeming, monetizing, and managing the compensation and rewards that are provided in exchange for access to the members' private data. This application is related to copending application Ser. No. 15/949,486, entitled CONSUMER DATA AND PRIVACY CONTROLS IN A SOCIAL NETWORKING ENVIRONMENT, filed on Apr. 10, 2018, the specification of which is incorporated by reference herein.

More particularly, the present invention is related to providing compensation and rewards for access to data on actions taken by users who are members of one or more social networks. Payments in the form of micro-bits, aspirational and/or experiential rewards, reward points, frequent flyer miles, alternative currencies, goods and services, i.e. barter as well as other tangible and non-tangible benefits are earned, won or granted for access to the user's data. In each instance, a commercial relationship is established between the social network and the user whereupon the user is compensated for access to their profile information (data), which includes a record of online actions they take within the social network (e.g. sharing or liking something) as well as outside the network (e.g. web browsing). This changes the fundamental dynamics of the relationship between the social networks and the users, whereby issues regarding ownership and utilization of users' data and content, and users' privacy, are clearly defined by allowing the users to generate value through each and every action they take and have taken, to the degree that they allow. This results in the underpinnings of a sharing economy, in which users may share in revenue generated through the use of their data, which they may selectively share with third parties as desired.

### BACKGROUND OF THE INVENTION

In the prevalent online world, consumers generate an immense amount of data regarding their interaction with others, web browsing, ecommerce transactions, and the like. In particular, consumers' increased usage of social networks such as FACEBOOK or TWITTER in which members share images and videos, and have interactive chat sessions with messaging to select members of their social network, and other social and data networks, has caused an exponential increase in the amount of data available regarding their online activities. Social networking services that are currently implemented often gather information from their members in a surreptitious manner, whereby the members do not even know that their information is being used, or that their activities are being tracked, etc. Users of social networks (also referred to interchangeably as members) therefore have great value, which may vary as it pertains to different third parties such as marketers, advertisers, manufacturers and the like.

Advertisers and other third parties have a great desire to access the data collected by social networks since that data indicates preferences for various products, services, interests, and the like. That is, since members of social networks often have common interests and socioeconomic status, it is desired to be able to utilize the vast amounts of information available from those members in order to market various products and services.

It is therefore desired to address these issues of data privacy and control by consumers to give consumers complete control over the access to and use of their data by third parties, and to compensate the consumers for granting such access. It is also desired to enable consumers to determine and control which third parties may have access to their data, as well as what data may be seen. It is further desired to enable consumers to determine and control which third parties may push to them certain advertisements and other marketing information, as well as what types of information will be pushed to them. To do this, it is desired to provide members of social networks with incentives, rewards and other compensation for providing their information and allowing use of that information by third parties.

It is therefore also desired to collect data from members of social networks, which includes data regarding a primary member and other members of their social networks, and analyze that data to provide more meaningful information to third party marketers as well as compensation to the members for use of their data, wherein the members have granular and defined control over the use of their data. Social network data collection and analysis implements a layered approach under this invention, wherein the members act as nodes and the data collection can travel deep into various social networks and sub-networks as may be permitted and desired.

Prior art incentive systems are typically implemented utilizing reward points and other types of purchase incentives (e.g. rebates, coupons, and the like). While reward points are quite useful if managed properly, many consumers desire payment incentives in the form of currency, which is fungible and interoperable with any payment system. That is, if a consumer is rewarded with reward points, he or she would be limited in their ability to redeem those points at various merchants; while payment in the form of a currency allows the consumer to spend that currency at any merchant. However, payment or reward in the form of currency is problematic and presents challenges that have not been addressed in the prior art.

Blockchain is a technology that enables anonymous and decentralized management of data in a reliable and secure manner. This provides many advantages, and in particular provides a means under the current invention described herein to address the deficiencies in the prior art as explained above. In particular, the use of a blockchain to award, track, aggregate, segment, and redeem rewards (referred to herein as micro-bits) under this invention provides advantages not available in prior art reward systems.

### SUMMARY OF THE INVENTION

Provided is method of and system for enabling users to manage and control access to and utilization of the data that is collected by web sites, social networks and the like regarding their online and offline interactions, and operating a rewards-based social network wherein rewards are issued by a third party to a member of the social network in exchange for providing access to that online interaction profile data of the member and their networked members, wherein the profile and/or rewards may be stored in one or more records in a blockchain ledger. The rewards may take the form of a virtual currency, cryptocurrency, cash currency, reward points and miles, store credits, bartered goods and services, micro-bits, and the like. Users can manage their profile data, and accordingly the compensation they receive from third parties for access to their profile data, through an app executing on a portable device such as their phone or tablet, and/or through a similar web interface provided by the social network service.

In particular, provided is a method of and system for members of a social network to control access to and utilization of their data. Static information associated with the member is acquired, and computer-based activities of the member are recorded in order to generate dynamic information associated with the member. A set of member preferences are then acquired from the member, the member preferences including an identification of at least one third party to whom access to the member profile is granted by the member in exchange for compensation to the member, which may include a cash reward, cryptocurrency rewards, reward points, and/or purchase incentives. A member profile is constructed including the static information associated with the member, the dynamic information associated with the member, and the member preferences. The member profile is transmitted to the third party identified in the member preferences, and compensation is provided to the member in exchange for access to the member profile.

Optionally, the member preferences may additionally include an identification of a subset of the member profile to which the third party is granted access by the member in exchange for compensation to the member. Further optionally, the member preferences additionally include an identification of at least one third party from whom the member agrees to receive information pushed to a member computer operated by the member in exchange for compensation to the member as well as an identification of a type of information that the member agrees to receive that is pushed to a member computer operated by the member in exchange for compensation to the member.

Typically, the member preferences are input by the member operating an app executing on a mobile device.

In one embodiment, the step of collating into a member profile the static information associated with the member, the dynamic information associated with the member, and the member preferences includes analyzing the member profile and executing an automated decision regarding the profile based on the results of the analysis.

In an alternative embodiment, the member is provided with an option to enter an opt-in mode or an opt-out mode. The opt-in mode requires the member to select the identification of at least one third party to whom access of the member profile is granted by the member in exchange for compensation by the third party to the member. The opt-out mode requires the member to de-select the identification of any third party to whom access of the member profile is not granted by the member in exchange for compensation by the third party to the member, whereby any third party not de-selected will be granted access to the member profile by default.

In a further alternative embodiment, the member is a primary member of a social network that has a plurality of secondary members to whom the primary member is linked, each of the secondary members having an associated secondary member profile that includes static information associated with the secondary member; recorded dynamic computer-based activities of the secondary member, and a set of member preferences acquired from the secondary member. In this embodiment, a network profile associated with the primary member is generated, based on an analysis of the secondary member profiles of the secondary member. Then, a data access process is executed, only when the member preferences of all of the secondary member profiles includes an identification of at least the same third party to whom access of the secondary member profile is granted by the secondary member in exchange for compensation. The data access process includes transmitting the network profile to the third party, providing compensation to the primary member and the secondary members in exchange for the network profile.

Preferably the member profile is stored in a blockchain ledger, and the member profile is updated by recording each computer-based activity to a record in the blockchain ledger. Additionally, the rewards are also recorded in the blockchain ledger.

### BRIEF DESCRIPTION OF THE DRAWING

FIG. 1 is a block diagram of a preferred embodiment of the invention.

FIG. 2 is a flowchart of the operation of an embodiment of the invention.

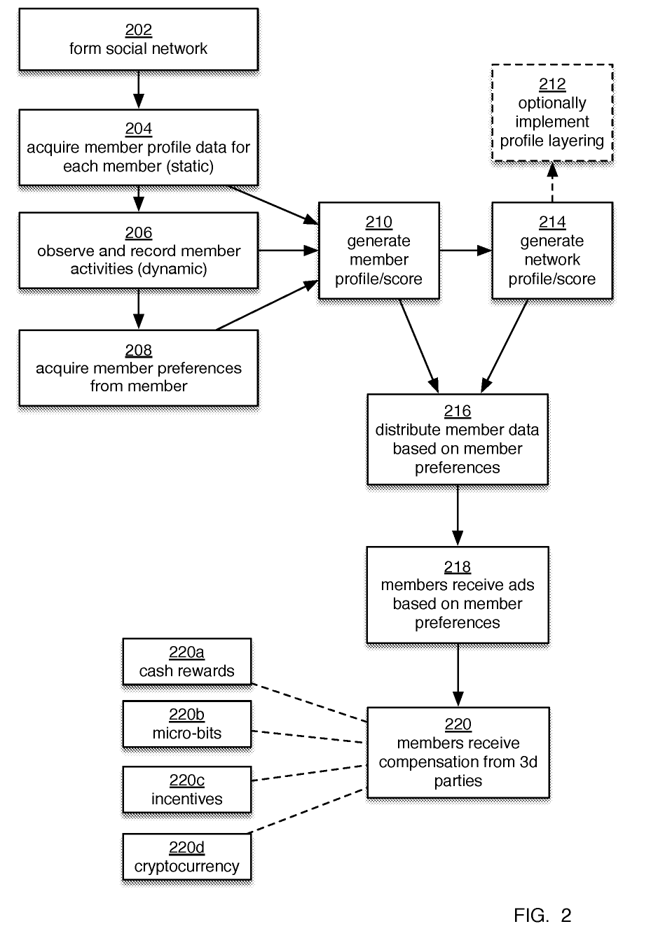

### DESCRIPTION OF THE PREFERRED EMBODIMENTS

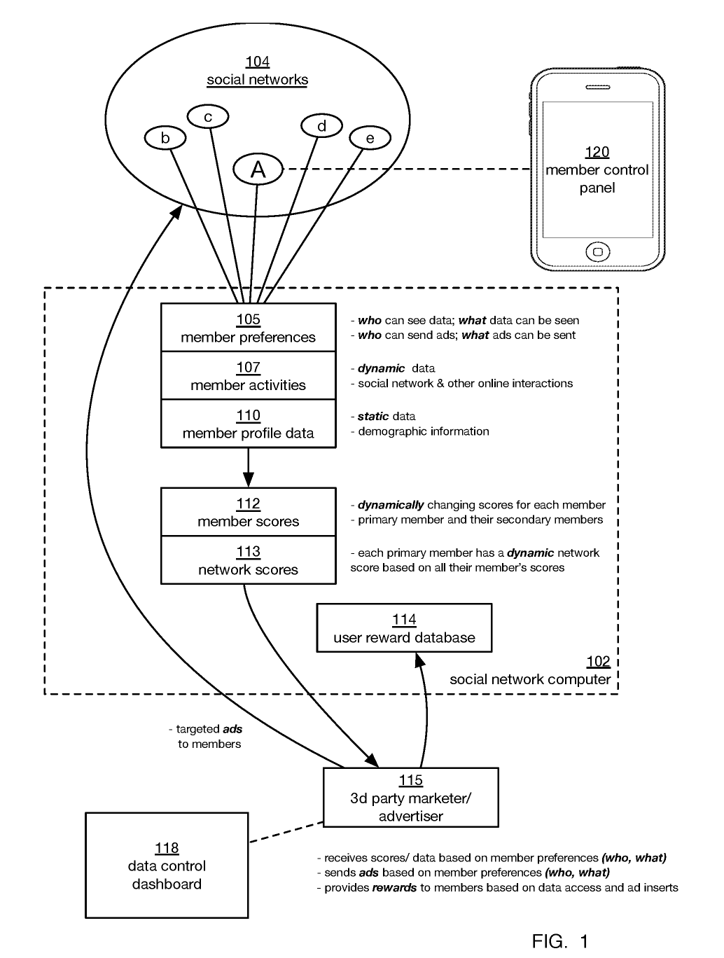

Social networks are constructs as well known the art that provide a communication paradigm amongst its various members. Social networks are groups of persons that interact with each other in some format(s), typically over an electronic communications network such as the Internet. Various social networking services exist, which facilitate interactions amongst the various constituent members that form the social networks. Examples of well-known existing social networking services include FACEBOOK and TWITTER. These services enable its members to define various social networks in which the members choose to link with (or friend) each other to share information, images, videos, emails, chat, etc. The viral marketing engine described herein piggybacks on the infrastructure of these types of social networks. For purposes of explaining the present invention and its embodiments, a primary member A (see FIG. 1) may form a social network with secondary members b, c, d and e. This would be referred to as social network A since member A is the primary member.

Any member of a social network 104 who is not the primary member of that social network is considered to be a secondary member of that network. Each member of the social networking service will be a primary member to one social network (defined by the secondary members to whom he has linked), and each member is a secondary member to the social networks of those in his social network.

Referring to the flowchart of FIG. 1, at step 202 the social network 104 may be formed amongst its various members utilizing the social network server computer 102 which runs the social networking service. The members of the social network 104 communicate with the social network server computer 102 by using various user computers (not shown), which may be desktop computers, laptop computers, tablets, smartphones, etc. These user computers communicate with the social network server computer 102 through a wired and/or wireless communications network(s) such as the internet. Typically, each member will register or enroll with the social network server computer 102 and indicate their desire to join a particular social network 104 by linking with at least one of the constituent members of that social network. Any member may invite any other member to join his network, for example by an email message as known in the art. For example, member A has requested members b, c, d and e to link to him, which they have all accepted. As the various members register with the social network server computer 102 and then link with each other, they will be able to interact with each other in various ways, including but not limited to the advertising and marketing interactions that will be described herein. Formation of social networks utilizing social network server computers and services is well known in the art.

### Member Profiles, Preferences and Scores

At step 204, each member of the social network 104 will provide their personal information and data to the social network server computer 102 for inclusion in a member profile 110 that will be stored in a profile database of the social network computer 102 as shown in FIG. 1. The member profile 110 will include various static pieces of information that are associated with the member, including but not limited to personal information of the member such as income, age, location, and occupation. Additionally, the member profile 110 may include a listing of the reward/loyalty/incentive programs with which the member is registered. These data types are referred to as static data types since the data generally will not vary over time and are only changed when the member requests such changes (e.g. moves and enters a new address into his profile).

In addition acquiring a member's static information as described above, the present embodiment of the invention will collect dynamic information of the member at step 206. This is recorded by observing a member's computer-based activities 107, such as but not limited to social network activities such as liking other members' posts, friending other members, sharing posts, posting images and text, etc. In addition, non-social network computer-based activities are observed and recorded, such as but not limited to the member's web browsing, online shopping, browsing and shopping habits, prior purchase transaction history photographs, etc. This is considered dynamic information since it continuously changes over time without being requested by the member, just by being observed by his computer. A member's computer-based activities are stored in the database at block 107.

At step 208, member preferences are also collected and stored in block 105. The member preferences enable the member to have control over at least the following:
who can see the data
what data can be seen
who can send ads to the member
what ads the member wishes to receive

Who can see the data—by setting these preferences, a member can control which third parties he or she will allow the social networking service to send his profile data. For example, the member may set a rule that allows only specifically identified third parties to access his data, or certain types of third parties, or he may set which third parties may not access his data, etc. These parameters may interplay with “what data can be seen” as explained below.

What data can be seen—by setting these preferences, a member can control what particular data may be sent out to third parties. For example, the member may specify that his browsing data may be released to all third parties, or that his shopping data may not be released, etc. This may be combined with “who can see the data”, for example the member may specify that company A may see his browsing data only but company B may see his shopping history, etc.

Who can send ads to the member—by setting these preferences, a member can control which third parties he or she will allow the social networking service to receive advertisements and other marketing information from and push to that member. For example, the member may set a rule that allows only certain named third parties to push ads to him through the social networking service, or certain types of third parties, or he may set which third parties may not push ads to him, etc. These parameters may interplay with “what ads the member wishes to receive” as explained below.

What ads the member wishes to receive—by setting these preferences, a member can control what particular ads may be received from third parties. For example, the member may specify that he is willing to receive ads for vacation properties, but not ads for concerts. This may be combined with “who can send ads to the member”, for example the member may specify that company A may push the vacation property ads to him only but company B may push concert ads to him, etc.

The member preferences as explained above are preferably controlled by the member interacting with an app that executes on his or her computer such as a mobile device. For example, a member may control his preferences via an app on his smartphone, which interacts with the social networking service. Likely the app will be provided by the social networking service and accessible by the member as desired. The preferences may be changed as desired by the member and may be continuously refined as he experiences the interaction with the service to tailor it to his specific requirements.

At step 210, the static profile data 110, the continuously collected dynamic profile data 107, and the member preferences 105 are constructed into a member profile. In addition, a member score is calculated at step 210 as a function of the various pieces of data in his profile. As such, the member's profile will continuously and dynamically shift in real-time depending on this changing data explained above. That is, the member's profile will vary (as well as his profile score) based on where the member is during the day, what they are doing, how they are interacting over the internet, etc. This is quite different from prior art profiling which is essentially static and does not change over time. By viewing the user as having a continuously and dynamically changing profile, and related profile score, the third parties gaining access to these members are given a much more accurate and meaningful picture of the members. The member profile score indicates the member's relative value to a third party marketer interested in gaining access to that member.

The member's profile score is generated as a result of analyzing the data in the profile. The score will be a numeric representation of the data and give the observer very simple insight into the data within the profile. An algorithm may be used to analyze the data and yield the score. The algorithm may be formulated by the system designer as desired. For example, the score may increase if the number of interactions over the web with a specified type of website (e.g. shopping) increase, or it may increase as the number of social network interactions increase, etc. The score may be comprised of multiple sub-scores that when viewed together yield a total score for that member. As a simple, example, a member with a shopping sub-score of 200 may be twice as active on shopping websites than a member with a shopping sub-score of 100. In some embodiments, the member's profile score may be generated and then accessed by a third party to see if that third party is interested in accessing the member profile data underlying the member profile score.

Network Profiles and Scores

In addition to individual member profiles and scores, each member will also have a network profile. At step 214, a member's network profile is generated based on an analysis of the constituent member profiles 110 (i.e. the primary member and all secondary members of that social network), and is stored in the profile database. The network profile is intended to be reflective of the information found in each of the constituent member profiles, and will subsequently be used in order to generate merchant incentives and other rewards and compensation. As such, each member will have an associated network profile 112 that is based on the individual member profiles of the secondary members in his own social network for which he is the primary member.

In one embodiment, the network profile 112 may reflect an average profile of all of the constituent member profiles (i.e. the primary members and all the secondary members). Averages may easily be generated for numerical data types; for example, the network profile may contain the average member age, the average income level, average household size, average number of years married, average height, average weight, average family size, etc. Data types that are not numerical may be analyzed to provide a quasi-average indication as well. For example, if most members live in the northeast region of the United States but a few live in the south region, then the network profile for those members may simply indicate that the average member lives in the northeast region.

Additionally (or in the alternative), the network profile 112 may reflect an aggregate profile of all of the constituent user profiles. For example, the network profile may indicate that 55% of the members are male and 45% are female, or it may indicate that 65% are adults and 35% are teenagers, or it may indicate that 4,657 of the 5,550 members graduated from college and the rest did not, or it may indicate that approximately half the members live inside the United States and half live outside the United States, etc.

Additionally (or in the alternative), the network profile 112 may reflect a comparison of its constituent members with non-members of that social network. For example, the network profile A for social network A may indicate that 80% of its constituent members work in the professional services industry compared to only 16% of the non-members of social network A.

In the embodiments wherein the members' profiles contain constantly-varying dynamic data as described above, the network profiles that are assembled as a function of those individual member profiles will likewise constantly vary. Other mechanisms for generating a network profile that is in some way representative of some or all of the constituent member profiles are also contemplated by this invention.

A network profile score is calculated at step 214 as a function of a member's network profile. As with the member profile score, the network profile score may be accessed by a third party to see if that third party is interested in accessing the underlying network profile data for that member's network. Under this invention, a member has value, and can monetize that value, as a function of the social network(s) that he belongs to, in particular when the value of the members in his social network(s) is high then his value is high since he will be perceived as being able to provide access to those valuable members by a third party. The network score can be calculated and assigned to each member as a function of their network profile. That network score would then be relatively higher when a member's social network has a high network profile. For example, if member B has a high value, then everyone that is networked with B will have a relatively higher value since member B adds to their score.

Members of a social network may then be compensated for access to and use of their profile data based upon member preferences as provided through the member's profile (and/or network profile). As the member profile is generated, that information may be provided to third party services such that revenue is generated and received by the social networking service as consideration for use of that information. This would be done after being given permission by the members for use of their information, whether individually (use by a third party of their own user profile) or in the aggregate (use by the third party of their information in the network profile) as set in the preferences. The member would then share in the compensation revenue received by the social networking service from the third party. In one case, revenue may be shared with only the primary member of the social network for use of the information from all of the members of his social network. In another case, revenue may be shared with the primary member of the social network and the secondary members of his social network for use of the information from all of the members of his social network. Third parties that may obtain member information from the various social networks via the social network server computer include merchants, rewards issuers, payment processors, and the like. Each of these third parties may have different uses for the information, but all would desire this information and as a result are willing to provide compensation to the member(s) for use of that information.

Thus, at step 218, the third party may access the member's user profile data and/or his network profile data, if permission is granted and in exchange for compensation to the member and/or his network members. Compensation may be in any form as agreed to between the member and the third party, typically through a setting in the member preferences explained above. Also, even though the third party will typically provide the compensation, the invention is not so limited, and any party could provide the compensation in exchange for access by the third party to the member's data.

In an alternative embodiment, members that have similar user profile scores may be grouped or aggregated together in an ad hoc manner for a particular campaign. That is, temporary networks may be formed of similar members having similar user profiles and profile scores even if those members are not already in each other's social networks, so that third parties can reach those with common profiles/interests on common ground.

A value quotient may be generated that indicates the meaningfulness in mathematical terms of the relationship between the primary user in each of his or her secondary relationships.

Blockchain Utilization

Blockchain is a continuously growing list of records, called blocks, which are linked and secured using cryptography. Each block typically contains a hash pointer as a link to a previous block, a timestamp and transaction data. By design, blockchains are inherently resistant to modification of the data. A blockchain can serve as an open, distributed ledger that can record transactions between two parties efficiently and in a verifiable and permanent way. For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

In this invention, a blockchain is preferably used to store an ongoing list of records (blocks), each of which stores a user activity that is used to generate the profile and related score. In addition, rewards granted to a member for access to his data may be stored in the blockchain.

A digital wallet is created using a blockchain, which may be carried by a user in a portable device such as a smartphone, smartwatch, and the like. As the user executes a transaction, such as allowing a merchant or other third party to access and utilize their data, that third party may issue micro-bits to that user by adding them to his blockchain ledger on his smartphone. In this manner, the user need not have an account stored at a centralized server computer as in the past, although the third party may optionally keep its own records of the transaction centrally if so desired. As the user earns rewards from the third party for allowing use of his or her data, his or her blockchain will be updated to reflect the additional rewards that have been earned. An application on the smartphone (or other device) may be implemented to enable the blockchain access. This application will also enable the user to determine how many micro-bits he has in his wallet.

At some point, the user may desire to utilize some or all of his micro-bits from his blockchain. A monetization transaction would then take place in which the rewards are deducted from the digital wallet in a subsequent blockchain transaction. The blockchain will keep a running record of all rewards added to the digital wallet as well as those taken from the wallet during the monetization process.

By using the blockchain ledger technology, the requirement for a centralized account is eliminated. Thus, when a consumer allows access to his social network data, the rewards transaction is recorded in the blockchain with requiring a central server. The consumer may then allow another third party to have access to his data, and have a subsequent rewards transaction recorded in his blockchain ledger. Again, this does not require the use of a central server since the blockchain ledger provides the digital wallet functionality.

Additionally, the use of a blockchain methodology in accordance with this invention provides the ability for parties including merchants, issuers, redeemers, and consumers to collaborate with each other without requiring any of the parties to have predetermined relationships established as in the prior art. Because the blockchain ledger is an independent entity and accessible to all parties independently, collaboration as required in the prior art is not required in this invention.

Implementation of the digital wallet with a blockchain ledger provides a carry-forward functionality not found in loyalty systems of the prior art. A consumer may earn rewards at each step of the chain, which are added piece by piece to his blockchain ledger. Different merchants may utilize different rules as desired, and the blockchain ledger will reflect implementation of those rules by the merchants as the user interacts and transacts business with those merchants.

Award and monetization rules may be changed on the fly by each merchant as desired, since the interactions with the blockchain at the point of sale does not require a centralized methodology as in prior art reward systems. These rules may apply to individual consumers, blocks of consumers, all consumers, etc., as may be desired by the merchant. Thus, each reward issuer may tailor its reward program and customize it instantaneously if desired.

By using the decentralized blockchain ledger as a digital wallet, synergies are realized not possible in the prior art. Alliances and coalitions between merchants may be formed, modified, dissolved, etc. in an instantaneous fashion, wherein blockchain rules may be adapted by each merchant along the chain. This provides an agile, modifiable ecosystem for providing and redeeming rewards amongst multiple merchants. Likewise, multiple consumers may be formed into groups by linking their blockchain ledgers without requiring a centralized server. For example, members of a family may form a group that can share rewards amongst them, accumulate them for increased monetization, trade rewards, etc.

By use of the blockchain ledger in the present invention, rewards may be modified in the ledger after they have been awarded. For example, rewards that have been added to a blockchain ledger may be varied as a function of time. Rewards may be reduced in value over time, which may provide an incentive for a consumer to monetize them rather than have them be reduced. This reduction in value need not follow any particular predetermined formula and may be varied in the ledger at will by the merchant that has awarded them. Also, rewards may be varied as a function of volume, whereby changes increase in rewards given by an issuer to its customers may cause the issuer to want to reduce the value of rewards already distributed in order to decrease its overall liability.

The blockchain ledger based reward system described herein thus has great applicability to social networking. Reward-based blockchains may be distributed, modified, adapted etc. by various members of a user's social network, with permissions for ledger access being provided based on social network status. Users may form coalitions to merge and exchange points amongst ledgers of various members within their social network, providing synergies otherwise unattainable in legacy reward systems.

As discussed, scoring methodology is employed that operates on data stored within the blockchain ledger, and which is updated and revised as data in that ledger changes.

Sources of data within the blockchain would include the value of transactions, the type of transactions, rewards that are awarded and/or redeemed for a transaction, and the like. The user may have a profile that gives him control over the data utilized in the scoring model, which will alleviate privacy concerns. For example, the user may want to allow the value of a transaction to be used in the scoring model, but not the type of product purchased or the merchant that the product is purchased from. Filters may be applied based on various data types, and the user may modify the profile as desired.

The scoring model may be implemented by an app operating in conjunction with the blockchain, for example residing on the device carrying the blockchain such as a smartphone. The user's score would be stored in the blockchain and accessible via outside parties as allowed by the user. For example, as part of a transaction, a merchant may access the user's score from the blockchain (and/or any supporting data from the blockchain if allowed by the user), which can be used to tailor the transaction to that user in a more beneficial manner. This score may act as a Q rating, similar to what is used to rate celebrities. The score may tie into and/or be based on the user's social network parameters as well.

In addition to user's implementing blockchain for loyalty and other transaction-based parameters, merchants may also implement a blockchain paradigm under this invention.

That is, a merchant may carry a blockchain that contains data regarding transaction with customers, rewards that have been awarded, rewards that have been redeemed, etc.

Fraud Prevention

Security and fraud avoidance is paramount in the present invention. In particular, it is envisioned that scammers will try to obtain data from users, via the social networking invention described herein, posing as reputable businesses. The present invention provides a security and anti-scamming mechanism intended to thwart such illicit actions.

Each third party that intends to interoperate with the system of the present invention and obtain data from users of social networks must first register with the social network service through a registration process. This registration process enables the social network service to review the credentials of the requesting third party in order to ensure they are a legitimate business and that they are who they say they are. Once the third party has been verified, it is issued a unique ID that must be used on all communications via the social network service from that point onwards. If at any time that unique ID is not present, or does not match the records of the social networking service, then any request to communicate with an of the members will be denied and flagged. This process will ensure the users of the system (members in particular) that any party requesting to access its data has been verified by the system.

In some embodiments, the third party provides compensation to the member that allows access to their data (and/or their network data) via the social networking service. In these cases, the third party will pay the social networking service, and in turn the social networking service will pay the member(s) that allowed access to their data and/or allowed the third party to push advertising and other information to their feed. In some cases, the third party will provide compensation directly to the member(s) and bypass the social networking service. Compensation in these cases is paid directly to an account or accounts associated with the member(s). In other cases, the third party may not pay the members but will direct another party to do so in their behalf.

In one embodiment, the member can publish his or her data directly to any interested third party in exchange for agreed-to compensation, thus bypassing the social networking service. In an alternative embodiment, an agent of the member may be implemented to make decisions on behalf of that member with respect to allowing access of which data to which third parties. That is, the agent may be given general instructions as to what types of transactions the member would like to execute. This relieves the member of having to constantly make decisions since the agent makes those decisions on his behalf. The member can of course always change his instructions to the agent in order to fine tune the decisions made by the agent. The agent may be a company formed in order to make these decisions on behalf of the member (likely many such members). In the alternative, artificial intelligence may be employed to make these decisions as an agent of the member. The AI will continually update and learn over time. AI is useful for setting member preferences as a function of external data acquired by the system.

A reporting methodology may be implemented in which the use of the data provided by the member is reported back to the member or his agent. A dashboard may be presented to the member on his app so he can review the data usage. For instance, compliance with the rules of usage established by the member may be verified. This may also be done automatically so that if there is a breach of compliance an alert is provided to the member so he may take steps as desired.

Optionally, instead of submitting the individual member profiles to the third parties, it is possible to submit an aggregate view of a number of members.

In one embodiment, the third party generates a desired profile view that is representative of the members that it would like to reach out to, and that desired profile is analyzed by the social network service with respect to the profiles of all of its members. When a match is found (i.e. a desired target member is a match to one or more actual member profiles, then offers for data access are made on behalf of the third party to those members in order to streamline the process described herein.

What is claimed is:

1. A method for members of a social network to control access to and utilization of their data comprising the steps of
acquiring static information associated with a member;
recording computer-based activities of the member to generate dynamic information associated with the member;
acquiring from the member a set of member preferences;
collating into a member profile the static information associated with the member, the dynamic information associated with the member, and the member preferences;
wherein the member preferences comprises an identification of at least one third party to whom access to the member profile is granted by the member in exchange for compensation to the member;
transmitting the member profile to the third party identified in the member preferences; and
providing compensation to the member in exchange for access to the member profile.

2. The method of claim 1 wherein the member preferences additionally comprise an identification of a subset of the member profile to which the third party is granted access by the member in exchange for compensation to the member.

3. The method of claim 1 wherein the member preferences additionally comprise an identification of at least one third party from whom the member agrees to receive information pushed to a member computer operated by the member in exchange for compensation to the member.

4. The method of claim 1 wherein the member preferences additionally comprise an identification of a type of information that the member agrees to receive that is pushed to a member computer operated by the member in exchange for compensation to the member.

5. The method of claim 1 wherein the member preferences are input by the member operating an app executing on a mobile device.

6. The method of claim 1 wherein the compensation comprises a cash reward, cryptocurrency rewards, reward points, and/or purchase incentives.

7. The method of claim 1 wherein the step of collating into a member profile the static information associated with the member, the dynamic information associated with the member, and the member preferences comprises analyzing the member profile and executing an automated decision regarding the profile based on the results of the analysis.

8. The method of claim 1 further comprising
providing to the member an option to enter an opt-in mode or an opt-out mode, wherein
the opt-in mode requires the member to select the identification of at least one third party to whom access of the member profile is granted by the member in exchange for compensation to the member; and
the opt-out mode requires the member to de-select the identification of any third party to whom access of the member profile is not granted by the member in exchange for compensation to the member, whereby any third party not de-selected will be granted access to the member profile by default.

9. The method of claim 1 wherein
the member is a primary member of a social network comprising a plurality of secondary members to whom the primary member is linked, each of the secondary members having an associated secondary member profile comprising static information associated with the secondary member, recorded dynamic computer-based activities of the secondary member, and a set of member preferences acquired from the secondary member;
further comprising the steps of
generating a network profile associated with the primary member, based on an analysis of the secondary member profiles of the secondary members;
executing a data access process only when the member preferences of all of the secondary member profiles comprises an identification of at least the same third party to whom access of the secondary member profile is granted by the secondary member in exchange for compensation, the data access process comprising
transmitting the network profile to the third party;
providing compensation to the primary member and the secondary members in exchange for the network profile.

10. The method of claim 1 wherein the steps are executed by a social networking computer interconnected with a plurality of member computers and at least one third party computer.

11. The method of claim 1 wherein the steps are executed by one of a plurality of member computers interconnected with a social networking computer and at least one third party computer.

12. The method of claim 1 wherein the member profile is stored in a blockchain ledger, and wherein the member profile is updated by recording each computer-based activity to a record in the blockchain ledger.

13. The method of claim 12 wherein the compensation comprises rewards that are recorded in the blockchain ledger.

14. A computing system for members of a social network to control access to and utilization of their data, comprising a social networking computer interconnected with a plurality of member computers and at least one third party computer; wherein the social networking computer or at least one of the plurality of member computers is programmed to
acquire static information associated with a member;
record computer-based activities of the member to generate dynamic information associated with the member;
acquire from the member a set of member preferences;
collate into a member profile the static information associated with the member, the dynamic information associated with the member, and the member preferences;
wherein the member preferences comprises an identification of at least one third party to whom access to the member profile is granted by the member in exchange for compensation to the member;
transmit the member profile to the third party identified in the member preferences; and
provide compensation to the member in exchange for access to the member profile.

15. The system of claim 14 wherein the member preferences additionally comprise an identification of a subset of the member profile to which the third party is granted access by the member in exchange for compensation to the member.

16. The system of claim 14 wherein the member preferences additionally comprise an identification of at least one third party from whom the member agrees to receive information pushed to a member computer operated by the member in exchange for compensation to the member.

17. The system of claim 14 wherein the member preferences additionally comprise an identification of a type of information that the member agrees to receive that is pushed to a member computer operated by the member in exchange for compensation to the member.

18. The system of claim 14 wherein the compensation comprises a cash reward, cryptocurrency rewards, reward points, and/or purchase incentives.

19. The system of claim 14 wherein the social networking computer or at least one of the plurality of member computers is further programmed to
provide to the member an option to enter an opt-in mode or an opt-out mode, wherein
the opt-in mode requires the member to select the identification of at least one third party to whom access of the member profile is granted by the member in exchange for compensation to the member; and
the opt-out mode requires the member to de-select the identification of any third party to whom access of the member profile is not granted by the member in exchange for compensation to the member, whereby any third party not de-selected will be granted access to the member profile by default.

20. The system of claim 14 wherein
the member is a primary member of a social network comprising a plurality of secondary members to whom the primary member is linked, each of the secondary members having an associated secondary member profile comprising static information associated with the secondary member, recorded dynamic computer-based activities of the secondary member, and a set of member preferences acquired from the secondary member;
wherein the social networking computer or at least one of the plurality of member computers is further programmed to
generate a network profile associated with the primary member, based on an analysis of the secondary member profiles of the secondary members;
execute a data access process only when the member preferences of all of the secondary member profiles comprises an identification of at least the same third party to whom access of the secondary member profile is granted by the secondary member in exchange for compensation, the data access process comprising
transmitting the network profile to the third party;
providing compensation to the primary member and the secondary members in exchange for the network profile.

21. The system of claim 14 wherein the member profile is stored in a blockchain ledger, and wherein the member profile is updated by recording each computer-based activity to a record in the blockchain ledger.

22. The system of claim 14 wherein the compensation comprises rewards that are recorded in the blockchain ledger.
